(19) United States
(12) Patent Application Publication
(10) Pub. No.: US 2007/0199423 A1
(43) Pub. Date: Aug. 30, 2007

(54) APPARATUS AND METHOD FOR ULTRASONIC CUTTING

(76) Inventor: Roberto Capodieci, Glen Ellyn, IL (US)

Correspondence Address: Pauley Petersen & Erickson;Suite 365, 2800 West Higgins Road, Hoffman Estates, IL, 60169, US

(21) Appl. No.: 11/624,951

(22) Filed: Jan. 19, 2007

Related U.S. Application Data
(60) Provisional application No. 60/760,566, filed on Jan. 20, 2006.

(51) Int. Cl. B26D 5/08

(52) U.S. Cl. 83/615

(57) ABSTRACT

This invention relates generally to cutting product by ultrasonic tools and methods. Specifically, the invention relates to an elongated cutting element removably coupled to an ultrasonic resonant horn to form a cutting zone and a method of use. The elongated cutting element can include simple, less costly, easily replaceable elements that resonate at ultrasonic frequencies but don't follow complex and restrictive acoustic rules.

### CROSS REFERENCE TO RELATED APPLICATION

This application claims the benefit of U.S. Provisional Application No. 60/760,566 filed on 19 Jan. 2006.

### BACKGROUND OF THE INVENTION

1. Field of the Invention

This invention relates generally to cutting product by ultrasonic tools and methods. Specifically, the invention relates to an elongated cutting element removably coupled to an ultrasonic resonant horn to form a cutting zone and a method of use. The elongated cutting element can include simple, less costly, easily replaceable elements that resonate at ultrasonic frequencies but don't follow complex and restrictive acoustic rules.

2. Discussion of Related Art

The advent of ultrasonic cutting technology in the last decade has thoroughly revolutionized the cutting operations of many industries including the food industry. However, even today, many new applications have to face the perceived high cost of ultrasonic components. Among such components, depending on the nature of the application, ultrasonic horns frequently top the list as the most expensive components even surpassing the cost of power supplies. For ultrasonic horn construction it is well known that, along with the use of expensive materials like titanium alloys, strict acoustic principles must be followed. For instance, the height of a blade horn must be exactly equal to half the wave length of the speed of sound in the particular material being used and commonly referred to as a half wave horn or a multiple of it, typically double and commonly referred to as a full wave horn. Moreover, the length of a horn is also significantly limited by other factors such as amplitude uniformity, frequency stability and reliability.

As an additional aspect, the typical horn profile entails during its fabrication a significant waste of expensive alloy while the mechanical characteristics of the alloy require a very slow machining process. These facts compound the ultimate cost of the finished horn.

The use of composite horns, i.e., a combination of multiple resonant elements connected to a common mother horn, although it is an option often used to contain the cost of the overall installation. However, composite horns are also costly, since their fabrication requires complex and expensive joining techniques such as: proprietary brazing processes, electron beam welding or time consuming fastening with threaded studs.

While the high cost of ultrasonic horns contributes to the overall outlay of an ultrasonic cutting system, it has also a significant impact on its operating expenses. In fact, it is known in the art that ultrasonic horns are subject to extremely high stresses, due to their rapid contraction and expansion at the resonant frequency. Such condition is further enhanced for blade horns due to the sharp cross section transitions required by their extreme profile. Although, typically, the performance of blade horns is significantly compromised in favor of greater reliability by fabricating thicker blades and more blunt edge bevels, these blade horns are still frequently subject to frequency shifts and consequent cracking. In this event, even if, more often than not, the cracks are invisible to the naked eye, once the horn is cracked, it can no longer resonate at its natural frequency and it must be replaced.

Another reason for periodic replacement of the blade horns resides with the progressive wear that is sustained by the blade edge during normal operation due to the repetitive engagement with the product, often abrasive like in the case of confectionery products. In addition to the cost issue of the conventional ultrasonic cutting horns, there are other important aspects to be addressed.

First, conventional horn design typically involves a compromise between performance and reliability that more frequently favors the latter. Blades are frequently developed that are too thick and with blunt edge bevels of up to 15 degrees which make such designs unsuitable for many categories of food and non food products that don't have plastic or pliable characteristics. This is typical of crumbly or aerated products from baking processes, such as cookies, which under the wedge effect of a blunt thick blade break apart and crumble along unpredictable fault lines, resulting in unacceptable product appearance as well as intolerable scrap levels.

Secondly, there are several other categories of products which are presently cut by cold and hot wire technologies or super thin blades, obviously because they are incompatible with either a standard blade design or a conventional ultrasonic blade horn. This is the case of products like wafers, ice cream, cheese, dough and the like. For such products, the existing prior art ultrasonic equivalent technology offers little improvement in cutting performance or allowing new product line extensions.

For instance, any attempt to cut wafer stacks filled with anything different than the conventional creams such as, for example, caramel, jelly, marmalade, nuts, inclusions and the like, with the conventional wires or thin blades will have to contend with a variety of operational issues. The thin blades or wires will quickly build up with product and increase the cutting resistance which will cause deformation of the wafer stack; in turn the build up will eventually break loose and fall on the top of the finished products creating unacceptable quality issues.

As an additional example, any attempt to cut a rope of ice cream extrusion such as for ice cream bars with sticks that contains inclusions of different kinds such as, for example, candied fruit, nuts, chocolate drops and the like, with the conventional hot wire technology may not result in desired product. In fact, while the hot wire can plow through a plastic mass with reasonable speed and final result, it would not be able to cut any inclusion. On the contrary, as soon as a hot wire would engage an inclusion, it would push it through the product creating pronounced deformations.

Additionally, conventional ultrasonic blades during the cutting operations, inevitably, maintain contact with the cut surfaces of the product until the blade edge disengages the top the product during its up stroke. While this is tolerable by many products of plastic nature, there are a number of products that react negatively to the prolonged contact with abnormal melting, smearing and build-up on the blade. These effects are further pronounced depending on the thickness of the blade and the edge bevel angle. This is the case of co-extruded multicolor products as well as multilayer filled ones and other products which must be cut when hot. Such products would prefer being swept through by a thin and shallow blade which, by minimizing the time, area and force of contact with the cut surfaces of the product, will prevent all the above-mentioned side effects.

Finally, although the ability to execute a profiled cutting with suitably shaped ultrasonic blades is now possible such as, for example, as disclosed in published U.S. Patent Application 20040134327 and the entire contents of which are hereby incorporated by reference, this option is still an expensive one.

### SUMMARY OF THE INVENTION

It is desirable to provide the use of a simpler, less expensive, easily replaceable blade. From the foregoing, there is a need for an innovative approach that could lead to simple, less costly, easily replaceable cutting elements that, on the one hand can still resonate at ultrasonic frequencies while on the other hand, don't need to follow the complex and restrictive acoustic rules. Such new cutting elements, by virtue of compact overall dimensions and in particular extreme thinness, can sweep easily through a variety of products with minimal intrusion and maximum efficacy. Also, some of these elements can be profiled through stamping methods. All things combined, such cutting elements will further simplify the cutting operations as well as lead to an array of new products or line extensions.

It is also desirable to provide the following particular benefits. Desirable wafer manufacturing benefits include clean cuts with low forces, no product delamination and new fillings and/or inclusions. Desirable ice cream processing benefits include slices with no product distortion, faster cutting speeds, higher cutting rates, thin slices and inclusion cutting ability. Desirable cheese processing benefits include slices with a higher moisture content, inclusion cutting ability, dicing, portioning and slitting. Desirable converting Industry benefits include low cutting/scoring forces and higher rates. Foam application benefits include faster speeds and no burning and/or melting.

The above and other objects of this invention can be attained, at least in part, with an apparatus for cutting product including an ultrasonic resonant horn desirably having a resonant frequency of about 20 khz to about 40 khz and at least one elongated cutting element removably coupled to the ultrasonic resonant horn. The at least one elongated cutting element preferably extends across a cutting zone between a first mounting site on the ultrasonic resonant horn and a second mounting site which may be on a second ultrasonic resonant horn or an anchor point. The elongated cutting element can have a ratio of a width to a thickness of less than about 25 and/or ratio of a length to a thickness of about 150 to about 600.

Suitable elongated cutting elements may have a profiled shape and be drawn taught by a tensioning device. Elongated cutting elements may include rules or wires and are made of materials such as titanium, stainless steel and carbon steel. A rule may have a length of about 300 mm, a thickness of about 0.5 mm to about 2 mm and a width up to about 30 mm. A wire may include a round wire with a diameter of about 0.5 mm to about 3 mm, and/or a flat wire with a thickness of about 0.2 mm to about 2.5 mm and a width of about 2 mm to about 8 mm. According to a preferred embodiment of this invention, the elongated cutting element is attached at only a single mounting site.

The elongated cutting element may removably couple to the ultrasonic resonant horn in orientations such as, for example axial, perpendicular and/or transverse. The apparatus may include an arm mounted to the ultrasonic resonant horn and the at least one elongated cutting element removably coupled to the arm forming a bow structure. Still, other preferred embodiments include a rotational drive mechanism engaged with the ultrasonic resonant horn. Four elongated cutting elements can removably couple to the ultrasonic resonant horn at about 90 degree angles to each other.

Another object of this invention is to provide a method of cutting product including energizing an ultrasonic resonant horn having at least one elongated removably attached cutting element and contacting product with the at least one elongated removably coupled cutting element to form cut, sliced, slit, and/or portioned product which may include inclusions. This method may also include rotational movement from a rotational drive mechanism engaged with the ultrasonic resonant horn.

Other objects and advantages will be apparent to those skilled in the art from the following detailed description taken in conjunction with the appended claims and the drawings.

### BRIEF DESCRIPTION OF THE DRAWINGS

The above and other objects of this invention can be better understood when the specification is read in view of the drawings, wherein:

FIG. 1 is a sectional view of an apparatus for cutting product, according to one preferred embodiment of this invention;

FIG. 2 is a partial exploded view of a perpendicular orientation according to one preferred embodiment of this invention;

FIG. 3 is a sectional view of an apparatus for cutting product, according to one preferred embodiment of this invention;

FIG. 4 is a partial exploded view of an axial orientation according to one preferred embodiment of this invention;

FIG. 5 is a sectional view of an apparatus for cutting product with a rotational drive mechanism, according to one preferred embodiment of this invention;

FIG. 6 is a sectional view of an apparatus for cutting product with a second ultrasonic resonant horn, according to one preferred embodiment of this invention;

FIG. 7 is a sectional view of an apparatus for cutting product with a bow structure, according to one preferred embodiment of this invention;

FIG. 8A-8C are sectional views of rules, according to preferred embodiments of this invention;

FIG. 8D-8E are cross sectional views of rules according to preferred embodiments of this invention;

FIG. 9A-9B are cross sectional views of wires, according to preferred embodiments of this invention; and

FIG. 10 is a sectional view of a rotary configuration, according to one preferred embodiment of this invention;

FIG. 11 is a sectional view of an apparatus for cutting product with a composite horn, according to one preferred embodiment of this invention.

### DETAILED DESCRIPTION OF THE INVENTION

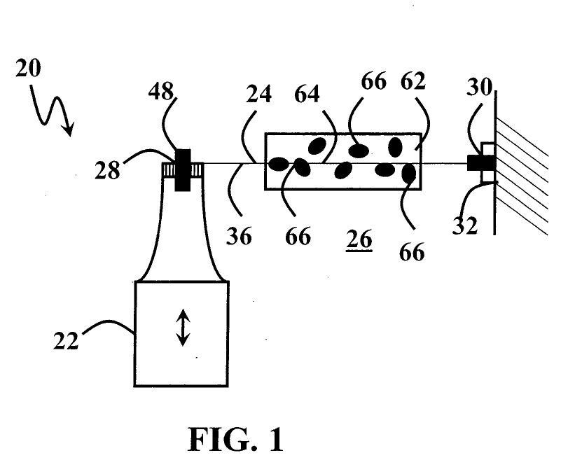

FIG. 1 shows a sectional view of apparatus 20 for cutting product 62 according to one preferred embodiment of this invention. Product 62 can include materials from various industries such as, for example, food, converting or any other industry with a need to cut, slice 64, slit, score, portion or otherwise modify product 62. Typically food items can include candies, breads, cakes, snacks, wafers 68, cookies, dough, pasta, chewing gum, ice cream, marshmallow, cheese and/or any other suitable material. Product 62 can include fillings such as creams, jellies and the like. Product 62 can also include inclusions 66 such as candied fruit, nuts, chocolate and the like. Product 62 can be of any required dimension or size to facilitate manufacture or end use requirements. Miniature sizes of product 62 can be manufactured. Product 62 from other industries may include pet food, paper, wax, foam, plastic and/or other suitable materials.

Apparatus 20 includes at least one ultrasonic resonant horn 22. Suitable ultrasonic resonant horns 22 can include simplex or composite horns, i.e., a plurality of smaller horns forming a larger horn, of various sizes and frequencies. According to a preferred embodiment of this invention, ultrasonic resonant horn 22 has a frequency of about 20 khz to about 40 khz. Ultrasonic resonant horn 22 desirably will excite elongated cutting element 24 at a frequency of about 20 khz to about 40 khz. Those skilled in the art and guided by the teachings herein will appreciate the desire to utilize simple, low cost convention ultrasonic drivers and/or generators.

At least one elongated cutting element 24 can be removably coupled, attached, mounted and/or fixed to ultrasonic resonant horn 22 at a first mounting site 28. Removably coupled can allow for interchangeable elongated cutting elements 24. Suitable solid connections transmit ultrasonic energy or are in ultrasonic communication between ultrasonic resonant horn 22 and elongated cutting element 24. Mechanical couplings or can include threaded connections such as nuts, bolts, studs, threaded tips, coupling device and/or the like. According to a preferred embodiment of this invention, elongated cutting element 24 is removably mounted by a bolt and a washer which is torqued according to ranges based on size and material as know by those skilled in the art. Inadequate mounting may result in significant localized frictional heat build up from the rapid expansion and contraction of the ultrasonic driver resulting in reliability, performance and/or failure of the cutting system.

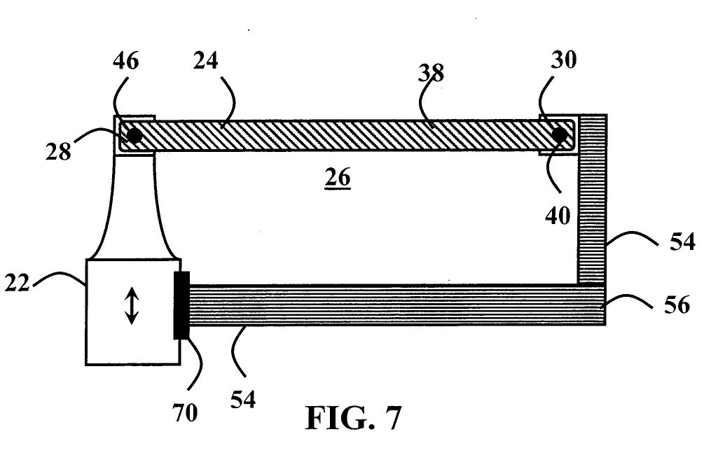

According to a preferred embodiment of this invention, mounting also includes tensioning device 40 to hold elongated cutting element 24 in a taught, drawn and/or stretched position. Tensioning device 40 can be used with both rule 36 and wire 38 type of elongated cutting elements 22. Tensioning device 40 desirably includes two components: a tensioning ring 78 with a suitable groove or slot 80 for the insertion of wire 38 end, and a threaded tip 74 and/or spacer 72 to clamp or hold tensioning ring to face of mounting site 28. Slot 80 can be a slit part way into or through the tensioning ring in a manner similar to stinging a guitar. Wire 38 can be wound around the tensioning ring and then can be clamped on the desired spot of the ultrasonic resonant horn 22 by a threaded tip. Tensioning device 40 can be placed on any mounting site 28 or more than one mounting site 28 including anchor point 32 as shown in FIG. 1 or arm 54 as shown in FIG. 7.

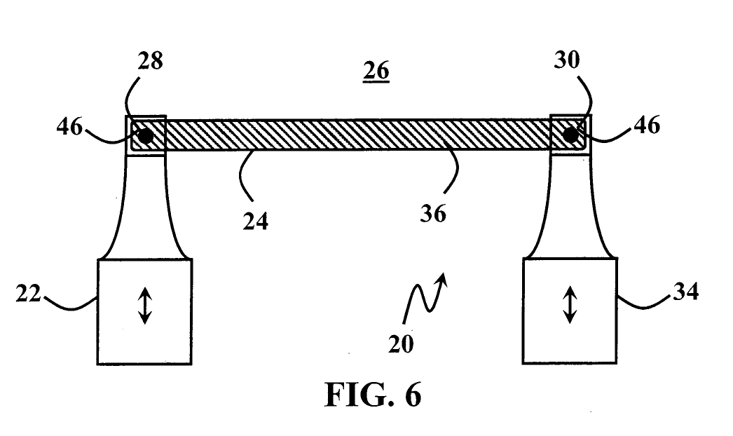

Second mounting site 30 can removably mount elongated cutting element 24 to first ultrasonic resonant horn 22, a second ultrasonic resonant horn 34 as shown in FIG. 6 or anchor point 32 as shown in FIG. 1. Anchor point 32 can include any location or place that is not itself ultrasonically driven and may be rigid, dampened, and/or isolated.

Elongated cutting element 22 can be rule 36, wire 38 and/or other suitably thin design to sweep easily through a variety of products 62 with minimal intrusion and maximum efficacy. Cutting zone 26 is formed by elongated cutting element 22 between first mounting site 28 and second mounting site 30. Apparatus 20 can have more than one cutting zone 26.

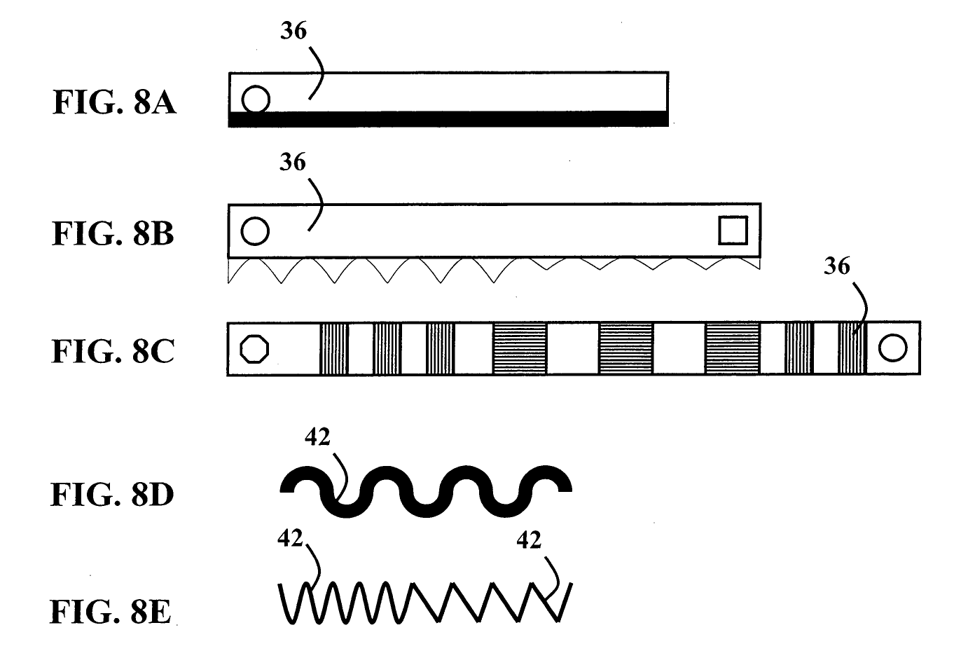

Rule 36 can be referred to as a band, a strip and/or a thin shallow blade. FIG. 8A shows rule 36 having a straight blade and FIG. 8B shows rule 36 having a serrated blade with varying teeth. FIG. 8C shows rule 36 having a profiled shape 42 as can be made by stamping methods and the like. FIGS. 8D-8E show possible cross sectional views of profiled shapes 42. Other combinations of edges or profiles are possible beyond those shown herein for illustration purposes. Suitable materials of construction for rule 36 can include carbon steel, stainless steel, titanium and/or any other materials of suitable hardness and compatibility with product 62. Preferably rule 36 has sufficient rigidity to properly function without tensioning device 40 and more preferably utilize a single mounting site 28.

Dimensions of rule 36 can desirably include: a length of about 300 mm; a thickness of about 0.5 mm to about 2 mm; and a height of up to about 30 mm. According to a preferred embodiment of this invention, elongated cutting element 24 has a ratio of width to thickness of less than about 25. According to another preferred embodiment of this invention, elongated cutting element 24 has a ratio of a length to a thickness of about 150 to about 600. Rule 36 can have one or more holes, apertures and/or bores located at the ends and/or anywhere in between the ends of rule 36 to facilitate attachment to a mounting site.

Wire 38 can be referred to as a cord, a string, a cable and/or a line. Suitable materials of construction for wire 38 include those discussed above for rule 36. Desirably, wire 38 includes inherent flexibility and merits the use of tensioning device 40. Proper tension can prevent wire 38 from operating in flexural modes.

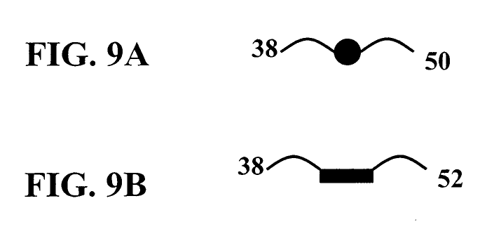

FIG. 9A shows a cross section of round/circular wire 50. FIG. 9B shows a cross section of flat/rectangular wire 52. Other wire 38 designs are possible beyond those shown herein for illustration purposes. Wire may be sharpened before installation and/or typically a suitable edge can be applied or sharpened once installed in apparatus 20. According to a preferred embodiment of this invention, dimensions for wire 38 are as follows: round having a diameter of about 0.5 mm to about 3 mm, more preferably about 2 mm; flat having a thickness of about 0.2 mm to about 2.5 mm, more preferably about 0.25 mm and having a width about 2 mm to about 8 mm, more preferably about 2 mm to about 4 mm.

Elongated cutting element 24 can be connected to ultrasonic resonant horn 22 in a variety of geometric configurations to optimize cutting performance and/or type of cut. Perpendicular 48, axial 44, and transverse 46 orientations are described below but other orientations are possible beyond those shown herein for illustration purposes.

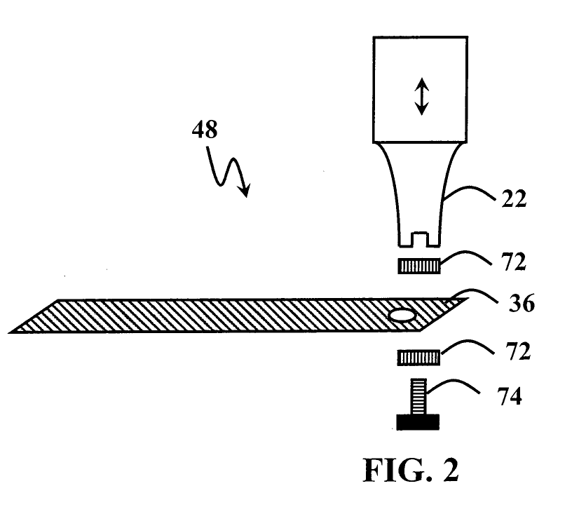

Perpendicular orientation 48, as shown in FIGS. 1-2, can be formed by placing the width of elongated cutting element 24 at a substantially right angle to the end of the ultrasonic resonant horn 22. Typically, but not necessarily, perpendicular orientation 48 includes mounting by a threaded connection aligned in an axial direction with the expansion and contraction of the ultrasonic resonant horn 22. FIG. 2 shows a partial exploded view of a perpendicular orientation 48 including washer or spacer 72 and bolt or threaded tip 74.

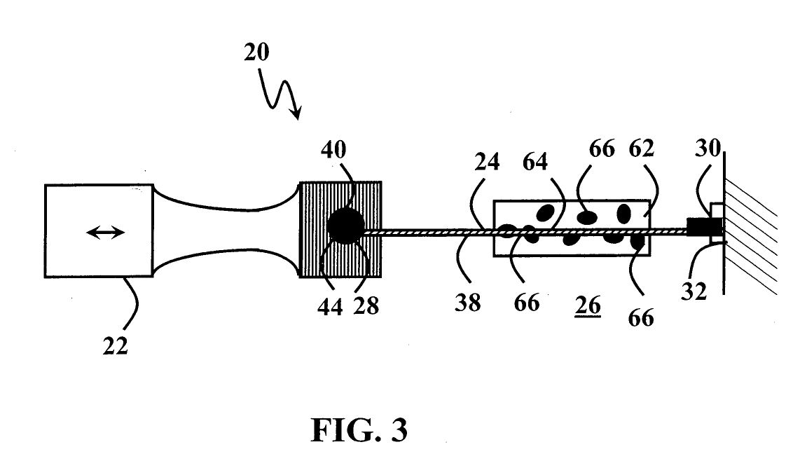

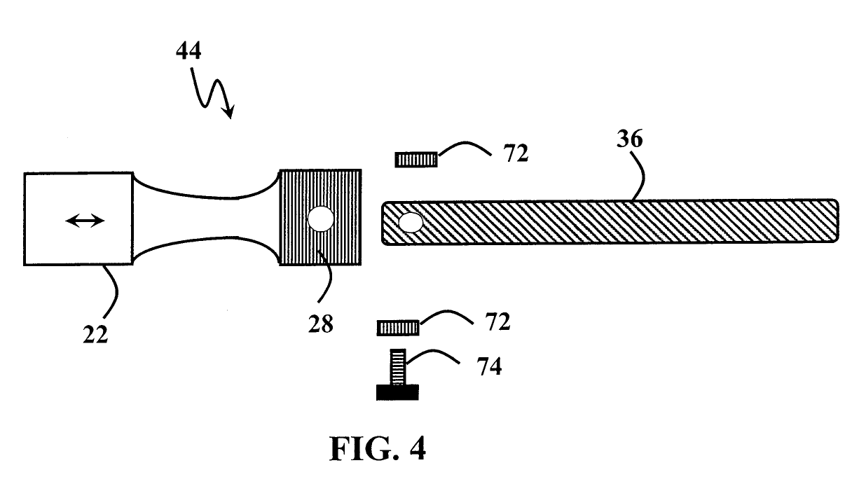

Axial orientation 44, as shown in FIGS. 3-4, can be formed by placing the width of elongated cutting element 24 substantially parallel to the end of the ultrasonic resonant horn 22. Typically, but not necessarily, axial orientation 48 includes mounting by a threaded connection aligned in a perpendicular direction to the expansion and contraction of the ultrasonic resonant horn 22. FIG. 3 shows a partial exploded view of an axial orientation 44 including washer or spacer 72 and bolt or threaded tip 74.

Transverse orientation 46, as shown in FIG. 6, can be formed by taking the axial orientation 44 and rotating elongated cutting element 24 to be substantially perpendicular to the end of the ultrasonic resonant horn 22. For example, cutting element 24 being vertical, i.e., blade side up and/or down, and having a perpendicular orientation 48 is distinguished from a transverse orientation 46 wherein cutting element 24 being horizontal, i.e., blade side left and/or right.

According to a preferred embodiment of this invention, as shown in FIG. 7, arm 56 can be attached and/or mounted to the ultrasonic resonant horn 22 and also removably attached to elongated cutting element 24. Cutting element 24 can form cutting zone 26 between ultrasonic resonant horn 22 and arm 56. Bow structure 56 may result from this configuration. Bow structure 56 may typically include nodal ring 70 attached, disposed and/or interposed between ultrasonic resonant horn 22 and arm 56.

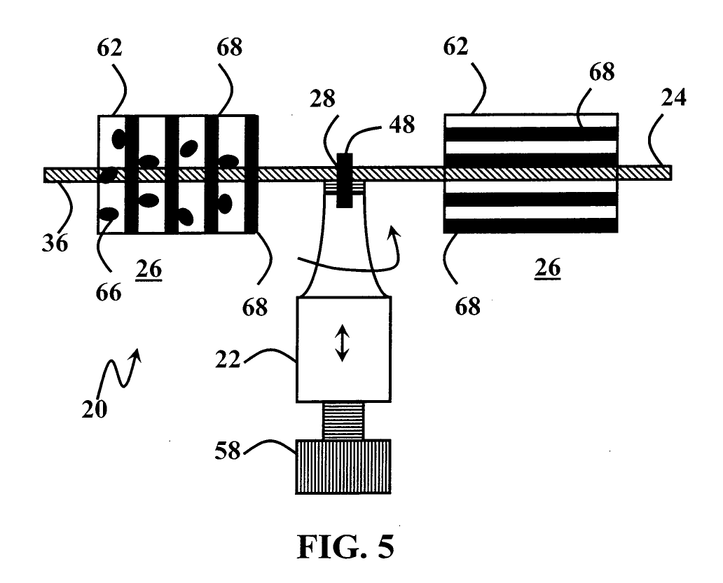

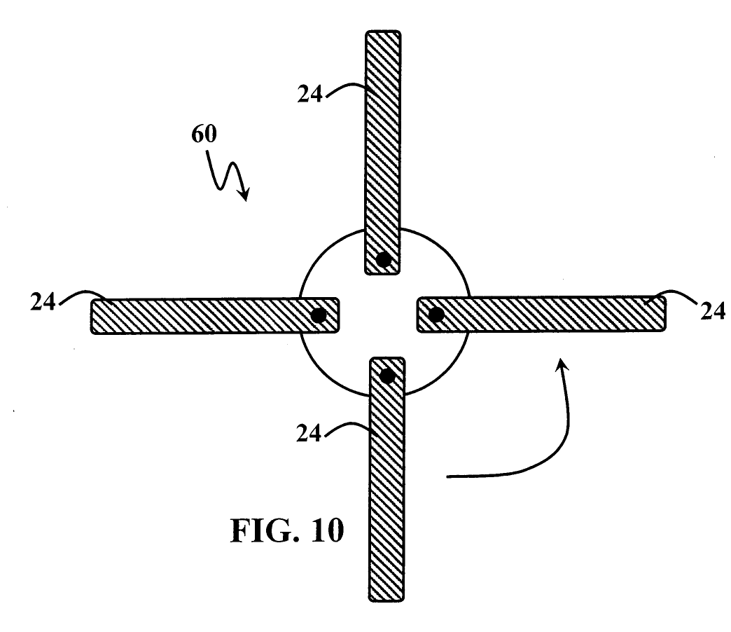

Rotational drive mechanism 58 may be provided to impart additional functionality to apparatus 20 as shown in FIG. 5. Rotary ultrasonic cutting may allow shapes and processes that are not possible with conventional reciprocating methods, such as for example creating miniatures. One or more elongated cutting elements 24 can be used in a rotary configuration wherein generally cutting elements can be arranged in a substantially symmetrical configuration or fashion. According to a preferred embodiment of this invention, as shown in FIG. 10, four cutting elements are arranged at substantially 90 degrees to each other to form rotary tip 60. Rotary tip 60 can be connected to one or more ultrasonic resonant horns 22 and one or more rotational drive mechanisms 58.

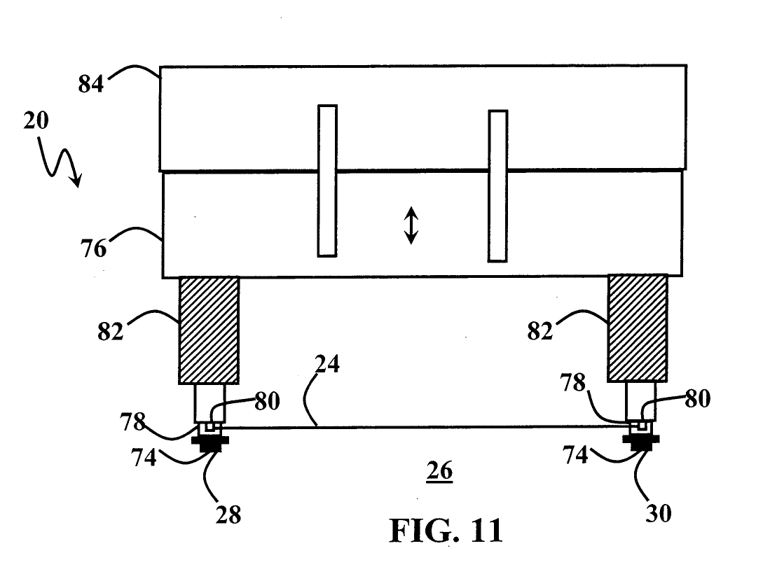

According to a preferred embodiment of this invention and shown in FIG. 11, a composite horn 76 supplies the ultrasonic motive force to apparatus 20. According to a preferred embodiment of this invention and as shown in FIG. 11, composite horn 76 includes a back driver or mother horn 84 and two front cylindrical resonant drivers 82 or arms with tips or ends. Other combinations of composite horn 76 elements are possible beyond those shown herein for illustration purposes.

Ultrasonic devices can be generally of any size needed from large fixed units to smaller portable ones. Preferably the unit is substantially rigidly attached and/or mounted to a suitable superstructure.

Methods for use of apparatus 20 for cutting product 62 include energizing or turning on an ultrasonic resonant horn 22 having at least one elongated removably attached cutting element 24. Contacting, exposing, and/or touching product 62 in cutting zone 26 with elongated cutting element 24 to form, slice, portion and/or shave product 62.

Additional configurations and/or steps are possible such as, for example, supplying product on a conveyor belt across the apparatus 20 or other suitable automation methods and/or equipment. In addition to rotational drive mechanism 58, other motive devices for elongated cutting element 24 are possible such as, for example, reciprocating movement, linear movement, circular movement, curved movement and the like. One skilled in the art and guided by the teachings herein will appreciate that ultrasonic cutting can be selectively applied such as, for example, when cutting a product having a hard top surface with an interior that maybe damaged by ultrasonic energy.

Combinations of apparatus 20 may be utilized to offer additional processing flexibility such as, for example, using multiple elongated cutting elements 24 arranged in a grid so that a block of product can be diced at one time. According to a preferred embodiment of this invention, an array or arrangement of of a plurality of resonant drivers 82 extend from one or more simplex ultrasonic resonant horns 22 and/or composite horns 76. Elongated cutting element 24 can be removably coupled to each resonant driver 82 and to an anchor point 32 so that product 62 can be sliced and/or diced when contacting elongated cutting element 24. Elongated cutting elements 24 can be arranged and/or configured in a substantially parallel manner or any other suitable combination.

While in the foregoing specification this invention has been described in relation to certain embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. An apparatus for cutting product comprising:
an ultrasonic resonant horn; and
at least one elongated cutting element removably coupled to the ultrasonic resonant horn, the at least one elongated cutting element extending across a cutting zone between a first mounting site on the ultrasonic resonant horn and a second mounting site.

2. The apparatus for cutting product of claim 1 wherein the at least one elongated cutting element has a ratio of a width to a thickness of less than about 25.

3. The apparatus for cutting product of claim 1 wherein the at least one elongated cutting element has a ratio of a length to a thickness of about 150 to about 600.

4. The apparatus for cutting product of claim 1 wherein the second mounting site comprises an anchor point.

5. The apparatus for cutting product of claim 1 further comprising a second ultrasonic resonant horn having a mounting site so that the at least one elongated cutting element extends between the first ultrasonic resonant horn and the second ultrasonic resonant horn.

6. The apparatus for cutting product of claim 1 wherein the at least one elongated cutting element comprises a rule.

7. The apparatus for cutting product of claim 1 wherein the at least one elongated cutting element comprises a wire, the wire removably coupled to at least one of the first mounting site and the second mounting site by a tensioning device, and the wire extending into the tensioning device.

8. The apparatus for cutting product of claim 1 wherein the at least one elongated cutting element has a profiled shape.

9. The apparatus for cutting product of claim 1 wherein the ultrasonic horn has a resonant frequency of about 20 khz to about 40 khz.

10. The apparatus for cutting product of claim 1 wherein a material of the at least one elongated cutting element is selected from the group consisting of titanium, stainless steel and carbon steel.

11. The apparatus for cutting product of claim 1 wherein the at least one cutting element removably couples to the ultrasonic resonant horn in an orientation with respect to the ultrasonic resonant horn selected from the group consisting of axial, perpendicular and transverse.

12. The apparatus for cutting product of claim 6 wherein the rule has a length of about 300 mm, a thickness of about 0.5 mm to about 2 mm and a width up to about 30 mm.

13. The apparatus for cutting product of claim 7 wherein a wire type is selected from the group consisting of a round wire with a diameter of about 0.5 mm to about 3 mm, and a flat wire with a thickness of about 0.2 mm to about 2.5 mm and a width of about 2 mm to about 8 mm.

14. The apparatus for cutting product of claim 1 further comprising at least one arm mounted to the ultrasonic resonant horn and the at least one elongated cutting element removably coupled to the arm forming a bow structure.

15. An apparatus for cutting product comprising:
a rotational drive mechanism;
an ultrasonic resonant horn engaged with the rotational drive mechanism; and
at least one elongated cutting element removably coupled to the ultrasonic resonant horn.

16. The apparatus for cutting product of claim 15 wherein at least two elongated cutting elements removably coupled to the ultrasonic resonant horn in a substantially symmetrical configuration.

17. An apparatus for cutting product comprising:
an ultrasonic resonant horn having a mounting site; and
at least one elongated cutting element removably coupled to the ultrasonic resonant horn, the at least one elongated cutting element having a thickness less than about 2.5 mm.

18. A method of cutting product comprising:
energizing an ultrasonic resonant horn having at least one elongated removably attached cutting element; and
contacting product with the at least one elongated removably coupled cutting element to form cut product.

19. The method of claim 18 wherein contacting by the cutting element includes rotational movement from a rotational drive mechanism engaged with the ultrasonic resonant horn.

20. The method of claim 18 wherein the product comprises inclusions.

21. The method of claim 18 wherein the cut forms on of the group consisting of a slice, a slit, and a portion.

22. An apparatus for cutting product comprising:
an ultrasonic composite horn with at least one pair of front resonant drivers;
at least one elongated removable cutting element coupled to the tips of the pair of the front resonant drivers and having a thickness of less than about 2 mm.

23. The apparatus for cutting product of claim 22 wherein the at least one elongated cutting element comprises a wire, the wire removably coupled to the tips of the front resonant pair of drivers by a tensioning device and a coupling device, and the wire extending into the tensioning device.

24. The apparatus for cutting product of claim 22 wherein the at least one elongated cutting element has a profiled shape.

25. The apparatus for cutting product of claim 22 wherein the at least one elongated cutting element comprises a rule.

26. The apparatus of claim 22 further comprising an array of resonant drivers and anchor points having at least one elongated cutting element removably coupled to each resonant driver and each anchor point.
